(19) United States
(12) Patent Application Publication
(10) Pub. No.: US 2020/0156015 A1
(43) Pub. Date: May 21, 2020

(54) CARBON NANOTUBE MEMBRANE

(71) Applicant: TECHNION RESEARCH & DEVELOPMENT FOUNDATION LIMITED, Haifa (IL)

(72) Inventors: Viatcheslav FREGER, Haifa (IL); Karen Adie TANKUS, Nesher (IL)

(73) Assignee: TECHNION RESEARCH & DEVELOPMENT FOUNDATION LIMITED, Haifa (IL)

(21) Appl. No.: 16/632,960

(22) PCT Filed: Jul. 23, 2018
(86) PCT No.: PCT/IL2018/050816

§ 371 Date: Jan. 22, 2020

Related U.S. Application Data
(60) Provisional application No. 62/535,906, filed on Jul. 23, 2017.

(51) Int. Cl. B01D 71/02; B01D 69/02; C02F 1/44; B01D 39/20; B01D 67/00; C02F 101/32

(52) U.S. Cl. CPC B01D 71/021; B01D 69/02; C02F 1/444; B01D 2325/02; B01D 67/0093; C02F 2101/32; C02F 2305/08; B01D 39/2055

(57) ABSTRACT

An article comprised of an oxidized carbon nanotube (CNT) membrane is disclosed. Incorporation of the article in a filtration system is further disclosed. A method for oxidizing a surface of a CNT membrane, e.g., by applying a direct-current (DC) potential in/on said CNT membrane is further disclosed.

### CROSS-REFERENCE TO RELATED APPLICATIONS

This application claims the benefit of priority from U.S. Provisional Patent Application No. 62/535,906 filed on Jul. 23, 2017 entitled: “CARBON NANOTUBE MEMBRANE”. The content of the above documents is incorporated by reference in its entirety as if fully set forth herein.

### FIELD OF INVENTION

The present invention, in some embodiments thereof, relates to carbon nanotube membranes and use thereof e.g., for filtration.

### BACKGROUND OF THE INVENTION

One of the main by-products of oil extraction is produced water, which is water combined with oil including small oil droplets and colloids. Environmental regulations demand thorough purification of produced water before reuse or discharge to the environment. Today's purification techniques are either expensive or not sufficient for complete removal of oil, in particular, concerning fine colloid fraction. That motivates research for novel approaches that enable an effective low-cost oil water separation down to smallest size.

Carbon nanotubes (CNTs) have been proposed for a number of potential applications, including electronic circuit applications such as field effect transistors, capacitors and/or ultra-capacitors, memory arrays, traces, and switches. Numerous other applications have been proposed as well, such as structural materials, heaters and heat transfer conduits, and numerous others.

### SUMMARY OF THE INVENTION

Unfortunately, carbon nanotube (CNT) pristine mats are hydrophobic, while oil rejection requires hydrophilicity and oleophobicity. To convert the mats to efficient filters, the present inventors have surprisingly uncovered a route to utilize the high electrical conductivity of the CNT and use electro-treatment to alter reversibly or irreversibly their wetting characteristics. This approach, may be conveniently applied in situ, i.e., within a working filtration unit. For instance, electro-oxidation (EO) under anodic potentials generated oxygen-containing polar groups on the CNT surface.

In one aspect, there is provided an article comprising a carbon nanotube (CNT) membrane, wherein at least one surface of the membrane is at least partially oxidized, and wherein the membrane is characterized by one or more properties selected from:
(a) Fourier transform infrared (FTIR) spectroscopy exhibiting bands in the range of: from 1000 cm⁻¹ to 1700 cm⁻¹, and from 3500 cm⁻¹ to 4000 cm⁻¹; and/or
(b) Raman scattering peaks at (i) 1580 cm⁻¹ (G-band), and at (ii) 1350 cm⁻¹ (D-band), wherein a ratio of peak (i) to peak (ii) is at least 20% lower compared to a corresponding ratio of the peaks of non-oxidized CNT membrane.

In some embodiments, the disclosed oxidized CNT membrane is characterized by permeability of water in the range from 100 to 2000 L/(m² h bar).

In some embodiments, the disclosed oxidized CNT membrane is characterized by oil breakthrough pressure of at least 0.5 bar.

In some embodiments, the disclosed oxidized CNT membrane is characterized by a Young's modulus value higher than the Young's modulus value of a nonoxidized pristine CNT membrane by 10% to 40%.

In some embodiments, the disclosed oxidized CNT membrane is characterized by an electrical conductivity value higher than the electrical conductivity value of a nonoxidized pristine CNT membrane by 60% to 80%.

In some embodiments, the disclosed oxidized CNT membrane comprises pores having a median size in the range of from 3 nm to 200 nm. In some embodiments, the CNT is a multi-walled CNT. In some embodiments, the CNT membrane is in the form of one or more non-woven sheets. In some embodiments, the article is selected from the group consisting of: a filtration device, an agricultural device, and a microfluidic device.

In some embodiments, the CNT membrane is characterized by oil breakthrough pressure of at least 0.5 bar.

In another aspect, there is provided a method for oxidizing a surface of a CNT membrane, the method comprising the step of: applying an electric potential (e.g., a direct-current (DC) potential), in the range of from +1V to +60V in/on the CNT membrane. In some embodiments, the applying electric potential is performed for a time duration of from 1 min to 60 min.

In another aspect, there is provided a separation system comprising the disclosed article in an embodiment thereof, the separation system further comprising a filtration unit and an inlet, wherein the filtration unit is configured to allow liquid to pass from the inlet to the membrane.

In another aspect, there is provided a separation system comprising a CNT membrane and a control unit, the control unit being configured to apply an electrical current in/on the membrane prior to the separation so as to oxidize a surface of the CNT membrane, wherein the CNT membrane comprises pores having a median size in the range of from 3 nm to 200, and wherein the separation system further comprises a filtration unit having an inlet configured to allow liquid to enter the filtration unit so as to pass through the membrane. In some embodiments, the control unit is configured to provide a membrane characterized by one or more properties selected from:
(a) Fourier transform infrared (FTIR) spectroscopy exhibiting bands in the range of: from 1000 cm⁻¹ to 1700 cm⁻¹, and from 3500 cm⁻¹ to 4000 cm⁻¹; and/or
(b) Raman scattering peaks at (i) 1580 cm⁻¹ (G-band), and at (ii) 1350 cm⁻¹ (D-band), wherein a ratio of peak (i) to peak (ii) is at least 20% lower compared to a corresponding ratio of the peaks of non-oxidized CNT membrane.

In some embodiments the disclosed system comprises CNT membrane characterized by permeability of water in the range from 100 to 2000 L/(m² h bar).

In some embodiments the disclosed system, in any embodiment thereof, is for use for separating water from an aqueous mixture comprising an organic matter.

In another aspect, there is provided a method for removing an organic matter from an aqueous mixture, the method comprising the steps of:
(i) providing the disclosed article in an embodiment thereof;
(ii) contacting the mixture with the CNT membrane; and
(iii) allowing the mixture to pass through the CNT membrane, thereby removing the organic matter from the aqueous mixture.

In some embodiments, at least 95% of the organic matter is removed from the aqueous mixture. In some embodiments, a concentration of the organic matter in the mixture is in the range of from 0.0001% to 10% by weight.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-1H present a schematic illustration of the electro-oxidative conversion of natively hydrophobic carbon nanotube (CNT) mats to hydrophilic oil-rejecting ultrafilters (FIG. 1A); a CNT coupon used for modificationa and filtration experiments (FIG. 1B); a scanning electron microscope (SEM) image (FIG. 1C; bar is 1 μm) and graphs showing pure water and oil permeability results for the pristine membranes (FIG. 1D); a shematic setup for in situ electro-treatment and filtration (FIG. 1E); a SEM image (FIG. 1F) and pure water and oil permeability results for electro-oxidized CNT membranes (FIG. 1G); FIG. 1H presents a non-limiting exemplary schematic illustration of the filtration process. Insets in FIG. 1D and FIG. 1G show contact angles of a sessile drop of water on corresponding CNT mats.

FIGS. 2A-2E present graphs showing thermogravimetric analysis (TGA) diagrams of CNT membranes before modification (as is), after pre-immersed in PE, and after electro-oxidation using indicated voltages and times (FIG. 2A); elastic modulus and electrical conductivity of CNT membranes before (pristine) and after electro-oxidation using indicated voltages and times (FIG. 2B); representative Raman spectra of CNT membranes before (pristine) and after electro-oxidation at 5 V for inidicated times (FIG. 2C); variation of G/D intensity ratio for membranes electro-oxidized for 30 min at different voltages (FIG. 2D); variation of G/D intensity ratio for membranes electro-oxidized at 5 V for different times (FIG. 2E).

FIG. 3 presents graphs showing Attenuated total reflectance-Fourier transform infrared (ATR-FTIR) spectra of CNT membranes before (0 V) and after modification for 30 min at oxidation voltages 5, 10, and 30 V.

FIGS. 4A-4E present time of flight ion mass spectrometry (TOF-SIMS) spectra of pristine and oxidized CNT membranes, representing mass spectrum signal of H⁻ (FIG. 4A), O (FIG. 4B), OH⁻ (FIG. 4C), (d) O₂⁻ (FIG. 4D), and O₂H⁻ (FIG. 4E) secondary ions, removed from the sample surface for pristine (black dotted line) and modified (red solid line, oxidized at 5 V for 30 min) CNT sheets.

FIGS. 5A-5B present graphs and corresponding Tables showing high resolution X-ray photoelectron spectroscopy (XPS) spectra of the C1s band of pristine (FIG. 5A) and oxidized (5V, 30 min), and CNT membranes and peak fitting results (FIG. 5B).

FIGS. 6A-6E present graphs showing the permeate flux (FIG. 6A) and total organic carbon (TOC) (FIG. 6B) vs. feed pressure for indicated electro-oxidation times; feed solution 1% PE with and without 0.4 mM Triton X100; a phot showing a non-limiting exemplary apparatus of feed and permeate during filtration experiment (FIG. 6C), a phase-contrast optical micrograph of the 1% PE feed solution stabilized with 0.4 mM Triton (FIG. 6D; bar is 20 μm), and a scheme showing forces acting on oil droplets next to the membrane surface during filtration of a stirred emulsion (FIG. 6E).

FIGS. 7A-7C present point graphs showing: TOC of permeate for same Triton concentration and different oil content (FIG. 7A); TOC of permeate in filtration experiments using CNT membranes modified using different voltages for 30 min and feed solutions containing 1% PE only (FIG. 7B) and 1% PE with added Triton X100 (FIG. 7C).

FIG. 8 presents a point graph showing TOC of the permeate as a function of the permeate volume during filtration of 1% PE and 0.4 mM Triton X 100 at 3 bar pressure, following soaking of the membrane in excess of the feed mixture overnight. The membrane was a CNT membrane modified at 15 V for 30 minutes.

FIGS. 9A-9B present permeate flux (FIG. 9A) and TOC (FIG. 9B) obtained in filtration experiments with and without applying 50V Alternating Current (AC) voltage during filtrations. The membranes tested were CNT mats electro-oxidized for 30 min by applying oxidizing Direct Current (DC) potentials 5, 10, 30, and 60 V.

### DETAILED DESCRIPTION OF THE INVENTION

The Article

According to one aspect of the present invention, there is provided an article comprising an oxidized carbon nanotube (CNT) membrane (interchangeably, also referred to as “mesh” or “mat”), such as, without limitation, a membrane made of intertwined CNTs. In some embodiments, by “oxidized” it is meant that at least one surface of the membrane is at least partially oxidized.

In some embodiments, by “oxidized carbon nanotube (CNT) membrane” it is meant to refer to dry oxidized carbon nanotube (CNT) membrane.

Non-limiting exemplary oxidation routes of CNT or CNT membrane are described in the Examples section.

In some embodiments, the oxidized CNT membrane is characterized by Raman scattering band(s) at about 1580 cm⁻¹ (referred to as “band (i)” or G-band) and at about (ii) 1350 cm⁻¹ (referred to as “band (ii)” or D-band), wherein, respectively, a ratio of intensities of band (i) to band (ii) is 10%, 15%, 20%, 25%, 30%, 35%, 40%, 45%, and 50%, including any value or range therebetween, lower compared to a corresponding ratio of the bands in non-oxidized CNT membrane.

In some embodiments, the oxidized CNT membrane is characterized by a Fourier transform infrared (FTIR) spectroscopy, exhibiting bands in the range of from 1000 cm⁻¹ to 1700 cm⁻¹ and/or from 3500 cm⁻¹ to 4000 cm⁻¹.

In some embodiments, the oxidized CNT membrane is further characterized by a water permeability in the range of from 200 L/(m² h bar) to 2000 L/(m² h bar). In some embodiments, the CNT membrane is further characterized by a water permeability in the range of from 100 L/(m² h bar) to 2000 L/(m² h bar). In some embodiments, the oxidized CNT membrane is further characterized by a water permeability in the range of from 200 L/(m² h bar) to 1000 L/(m² h bar). In some embodiments, the oxidized CNT membrane is further characterized by a water permeability in the range of from 200 L/(m² h bar) to 400 L/(m² h bar). In some embodiments, the water permeability is at least 50 to at least 350 L/m² h per bar applied, for example, at least 50 L/m² h per bar applied, at least 200 L/m² h per bar applied, at least 250 L/m² h per bar applied, at least 300 L/m² h per bar applied, or at least 350 L/m² h per bar applied.

In some embodiments, the oxidized CNT membrane is further characterized by a water permeability of 100, 200, 300, 400, 500, 600, 700, 800, 900, 1000, 1100, 1200, 1300, 1400, 1500, 1600, 1700, 1800, 1900, or 2000 L/(m² h bar), including any value and range therebetween.

In some embodiments, at least one of the oxidized CNT membrane's surface is further characterized by oil permeability through a wet membrane not exceeding 50 L/(m² h bar). In some embodiments, the surface is further characterized by oil permeability through a wet membrane not exceeding 40 L/(m² h bar). In some embodiments, the surface is further characterized by oil permeability through a wet membrane not exceeding 30 L/(m² h bar). In some embodiments, the surface is further characterized by oil permeability through a wet membrane not exceeding 20 L/(m² h bar).

Herein, the term “water permeability” refers to the volume of water that passes through the membrane per unit time, per unit area and per unit of transmembrane pressure. Similarly, the term “oil permeability” refers to the volume of oil or other hydrophobic water-immiscible liquid that passes through the membrane per unit time, per unit area and per unit of transmembrane pressure.

An “oily liquid” or “hydrophobic liquid” (also referred to in the art as a “lipophilic liquid”) is a substance which is liquid at room temperature and which is typically not dissolvable in aqueous solution and is dissolvable in non-polar organic solvents.

Exemplary hydrophobic liquids include, but are not limited to, organic substances such as alkanes, particularly long-chain alkanes, cycloalkanes, including bicyclic compounds, aryls (both substituted and unsubstituted), and fatty acids.

Oily liquids are hydrophobic substances which have an oily constitution and include, for example, natural and synthetically prepared oils such as olive oil, other plant and animal-derived oils, and inorganic oils such as silicon oil and other mineral oils.

Hydrophilic, amphiphilic and hydrophobic substances can also be determined by the partition coefficient thereof.

A partition coefficient is the ratio of concentrations of a compound in the two phases of a mixture of two immiscible liquids at equilibrium. Normally, one of the solvents chosen is water while the second is hydrophobic such as octanol. The logarithm of the ratio of the concentrations of the un-ionized solute in the solvents is called log P.

Hydrophobic liquids are characterized by LogP higher than 1; hydrophilic liquids are characterized by LogP lower than 1 and amphiphilic liquids are characterized by LogP of about 1 (e.g., 0.8 to 1.2).

In some embodiments, a “hydrophobic substance” is a substance which is not soluble or of limited solubility in water and other polar substances.

In some embodiments, the hydrophobic substance (also referred to as “water-insoluble”) is characterized in that at a pH of 7.0, is not dissolved by water and other polar substances.

In some embodiments, by “water-insoluble” it is meant that less than 50 weight percent, less than 20 weight percent, less than 10 weight percent, less than 5 weight percent, less than 1 weight percent, of the hydrophobic substance is soluble in water at about 25° C.

In some embodiments, the membrane is characterized as being hydrophilic.

In some embodiments, the dry oxidized CNT membrane is characterized by at least one improved mechanical property as compared to the property for the plain CNT. In some embodiments, the property is selected from, without being limited thereto, Young's modulus, tensile strength, fracture strain, yield point, toughness, work to failure, impact, tear strength, flexural modulus, flexural strain and stress at elongation.

In some embodiments, the dry oxidized CNT membrane is characterized by oil breakthrough pressure for water-wetted membrane of at least 0.5, at least 0.6, at least 0.7, at least 0.8, at least 0.9, or at least 1 bar.

The term “oil breakthrough pressure” refers to the pressure under which the membrane's pores are moistened by aqueous liquid phase and under which oil passes through the membrane along with water (regardless of membrane surface properties, e.g., hydrophilicity and oleophobicity). Without being bound by any particular theory or mechanism, the oil breakthrough pressure depends on the median mesh or pore size of the membrane.

In some embodiments, the elastic module of the oxidized CNT membrane is in the range of 1.6 to 2.5 Gpa, e.g., 1.6, 1.7, 1.8, 1.9, 2, 2.1, 2.2, 2.3, 2.4, or 2.5 Gpa, including any value and range therebetween.

In some embodiments, the oxidized membrane has an elastic modulus which is higher by 5% to 40%, e.g., 5%, 10%, 15%, 20%, 25%, 30%, or 35%, including any value and range therebetween, compared to a corresponding pristine (non-oxidized) CNT membrane.

In some embodiments, the phrase “elastic modulus” refers to Young's modulus of the dry oxidized CNT membrane. In some embodiments, the phrase “elastic modulus” is determined by response of a material to application of tensile stress (e.g., according to procedures known in the art).

In some embodiments, the ultimate tensile strength (UTS), (also referred to as “tensile strength”) of the oxidized CNT membrane is in the range of 60 to 100 Mpa, or, in some embodiments, 80 to 100 Mpa.

In some embodiments, the oxidized membrane has tensile strength which is higher by 5% to 60%, e.g., 5%, 10%, 15%, 20%, 25%, 30%, 35%, 40%, 45%, 50%, 55%, or 60%, including any value and range therebetween, compared to corresponding pristine (non-oxidized) CNT membrane.

In some embodiments, the ultimate tensile strength of the oxidized CNT membrane is e.g., 60, 65, 70, 75, 80, 85, 90, 95, or 100 Mpa, including any value and range therebetween.

In some embodiments, the tensile strength of a material refers the maximum amount of tensile stress that it can take before failure, for example breaking.

In some embodiments, the term “tensile strength” as used herein is the maximum amount of force as measured e.g., in Newton's that a material can bear without or prior to tearing, breaking, necking forming microcracks or fractures.

By “tearing, breaking, necking forming microcracks or fractures” it is meant to refer to a permanent deformation. In some embodiments, the term “permanent deformation” does not include microcracks or fractures. In some embodiments, by “permanent deformation” it is meant to refer to relative to at least 0.1%, at least 0.2%, at least 0.3%, at least 0.4%, at least 0.5%, or at least 1% of the original dimension or structure, including any value therebetween.

In some embodiments, the maximum strain of the oxidized CNT membrane is in the range of 3.8 to 13.8% or, in some embodiments, 7.5 to 13.7%.

In some embodiments, the maximum strain of the oxidized CNT membrane is e.g., 3.8%, 4%, 4.2%, 4.4%, 4.6%, 4.8%, 5%, 5.2%, 5.4%, 5.6%, 5.8%, 6%, 6.2%, 6.4%, 6.6%, 6.8%, 7%, 7.2%, 7.4%, 7.6%, 7.8%, 8%, 8.2%, 8.4%, 8.6%, 8.8%, 9%, 9.2%, 9.4%, 9.6%, 9.8%, 10%, 10.2%, 10.4%, 10.6%, 10.8%, 11%, 11.2%, 11.4%, 11.6%, 11.8%, 12%, 12.2%, 12.4%, 12.6%, 12.8%, 13%, 13.2%, 13.4%, 13.6%, or 13.8%, including any value and range therebetween.

The maximum strain is reflected as a maximum distance between the fiber ends.

In some embodiments, the oxidized CNT membrane has electrical conductivity which is higher by 20% to 80%, or in some embodiments, by 60% to 80% compared to a corresponding pristine (non-oxidized) CNT membrane.

In some embodiments, the oxidized CNT membrane has electrical conductivity which is higher by 20%, 30%, 40%, 50%, 60%, 70%, or 80%, including any value and range therebetween, compared to a corresponding pristine (non-oxidized) CNT membrane.

In some embodiments, the oxidized CNT membrane is characterized by an electrical conductivity of 90, 91, 92, 93, 94, 95, 96, 97, 98, 99, 100, 101, 102, 103, 104, 105, 106, 107, 108, 109, or 110 kS/m, including any value and range therebetween.

In some embodiments, the oxidized CNT membrane has a sheet resistance which is lower by 10%, 20%, 30%, or 40%, including any value and range therebetween, compared to a corresponding pristine (non-oxidized) CNT membrane.

In some embodiments, the oxidized CNT membrane is characterized by a sheet resistance of 0.20, 0.25, or 0.30, Ohm/sqr, including any value and range therebetween.

The term “sheet resistance” refers to a specific resistance per unit thickness of a thin layer.

In some embodiments, the oxidized CNT membrane is characterized by an X-ray photoelectron spectroscopy (XPS) signal of one or more members selected from, without being limited thereto, O⁻, OH⁻, O₂⁻, or O₂H⁻, which are at least 10%, at least 20%, at least 30%, at least 40%, at least 50%, at least 60%, at least 70%, at least 80%, at least 90%, at least 100%, at least 150%, at least 200%, at least 300%, at least 400%, or at least 500% higher compared to a corresponding pristine (non-oxidized) CNT membrane.

In some embodiments, the oxidized CNT membrane is characterized by an area density of 20, 20.5, 21, 21.5, 22, 22.5, or 23 g/m², including any value and range therebetween. The term “area density” as used herein refers to mass per unit area.

In some embodiments, the oxidized CNT membrane has an area density which is higher by 5%, 6%, 7%, 8%, 9%, 10%, 11%, or 12%, including any value and range therebetween, compared to a corresponding pristine (non-oxidized) CNT membrane.

In some embodiments, the term “carbon nanotube (CNT)” may refer to any of a number of cylindrically-shaped allotropes of carbon of the fullerene family including single-walled carbon nanotubes (SWNTs), double-walled carbon nanotubes (DWNTs), multi-walled carbon nanotubes (MWNTs). In some embodiments, CNTs may be capped by a fullerene-like structure or open-ended.

The terms “oxidized surface”, or any grammatical derivative thereof, refers to an oxygen-containing surface or a surface containing hydrophilic groups in general.

In some embodiments, the term “partially oxidized”, as used herein, encompasses the situations where the surface of the CNT membrane is fully oxidized, or, in some embodiments, a surface of the CNT membrane is partially oxidized, or, in some embodiments, some surfaces of the porous substrate are fully oxidized while others are partially oxidized, or not oxidized.

In some embodiments, by “partially” it is meant to refer to 1%, 5%, 10%, 20%, 30%, 40%, 50%, 60%, 70%, or 80%, of the surface, including any value and range therebetween.

As used herein, the term “hydrophilic”, when used in connection with a solid, means capable of being readily wet by water.

Methods for characterizing hydrophilicity of a surface are known in the art, e.g., by measuring the static contact angle of water on the surface, as exemplified in the Examples section below.

In some embodiments, the CNT membrane is characterized by a defined porosity e.g., as described below. In some embodiments, the porosity of the CNT membrane refers to the nanoporous networks within the CNT structure formed by intertwined individual CNTs or fibers formed by bundles of aggregated CNTs. In some embodiments, the porosity of the CNT membrane refers to the microporous networks.

In some embodiments, the term “porous” as used herein refers to a material characterized by porosity, e.g., comprises meshes, pores, holes, voids, or space, within its network. However, porous layers may optionally comprise an additional substance in the spaces between the carbon or carbonaceous material, nanotubes, bundles or fibers, provided that at least a portion of the volume of the voids is not filled in by the additional substance.

In some embodiments, the term “porosity”, as used herein, refers to the volume of the pores divided by the total volume of the porous substrate.

In some embodiment, the size of the pores is from 3 nm to 300 nm, e.g., 3 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 450 nm, or 500 nm, including any value or range therebetween. In some embodiments, “the size of the pores” refers to a median value of a plurality of mesh sizes or pores in the disclosed CNT membrane.

In some embodiments, the disclosed CNT membrane exhibits uniformity in the range of pore dimensions. In some embodiments, the disclosed CNT membrane exhibits uniform density of CNT material. By “dimensions” (or “size”), it is meant to refer to one or more dimensions (e.g., mesh size, length, or diameter).

By “uniformity”, or any grammatical derivative thereof, it is meant to refer to a variation of less than |±20%|, or, in some embodiments, less than |±10%|.

In some embodiments, the FTIR bands described herein, are indicative of surface structural defects and/or oxygen-containing groups present at the CNTs surface within the membrane described herein.

In some embodiments, the CNT membrane is in the form of a non-woven sheet.

In some embodiments, the phrase “non-woven” refers to a sheet, web or mat of directionally or randomly oriented fibers, where fibers are not intercalated but rather bonded through various means, including friction and/or cohesion and/or adhesion, e.g., π-π electron cloud interactions between the carbon nanotubes.

In some embodiments, the article comprising the CNT membrane described herein is selected from, without being limited thereto, a filtration device, agricultural device, or a microfluidic device.

Methods for Oxidizing CNT Membranes

According to one aspect of the present invention, there is provided a method for oxidizing a surface of a CNT membrane, comprising the step of applying an electric potential, in a desired range, (e.g., of from +1 V to +60 V) in/on to the CNT membrane. In some embodiments, the water further comprises an electrolyte solution, (e.g., 5 mM Na₂S_{O4}).

In some embodiments, the potential is a direct-current (DC) potential.

In some embodiments, by applying the DC potential the hydrophilicity of CNT membrane is increased.

In some embodiments, and without being bound by any particular mechanism, the surface of the membrane is modified via an electrochemical oxidation process, e.g., assisted by applying an electric potential. In some embodiments, the potential applied is a positive potential. In some embodiments, the potential is applied by a DC electrical source. In some embodiments, the electrochemical oxidation process is driven by applying a DC potential of 1V, 5V, 10y, 15V, 20V, 25V, 30V, 35V, 40V, 45V, 50V, 55V, or 60V, including any value and range therebetween, in/on to the CNT membrane.

In some embodiments, the electric potential is applied in/on to the CNT membrane for a time duration of from 1 min to 90 min. In some embodiments, the electric potential is applied to the CNT membrane for a time duration of from 5 min to 60 min. In some embodiments, the electric potential is applied to the CNT membrane for a time duration of 5 min, 10 min, 15 min, 20 min, 25 min, 30 min, 35 min, 40 min, 45 min, 50 min, 55 min, or 60 min, including any value and range therebetween.

The Systems

According to one aspect of the present invention, there is provided a first separation system comprising the article and the CNT membrane described herein. In some embodiments, the separation system further comprises a filtration unit and an inlet. In some embodiments, the filtration unit is configured to allow liquid to pass from the inlet to the membrane.

According to another aspect of the present invention, there is provided a second separation system comprising a CNT membrane. A membrane pore size embodiment of the CNT membrane is described here and above. In some embodiments, the separation system further comprises a filtration unit having an inlet. In some embodiments, the inlet is configured to allow liquid to enter the filtration unit and to pass through the membrane. In some embodiments, the separation system further comprises a control unit, configured to apply an electrical current in/on the membrane.

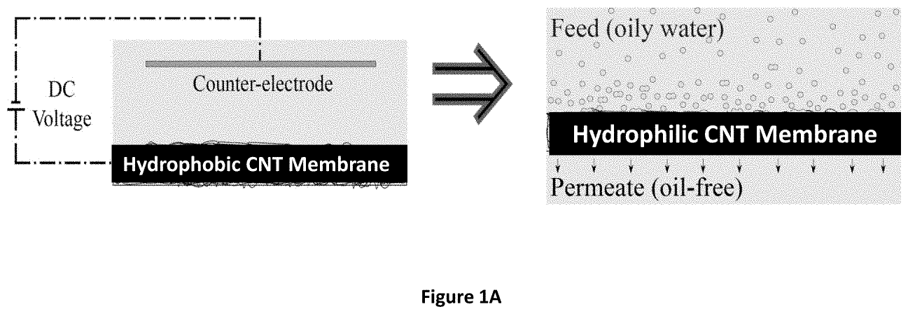

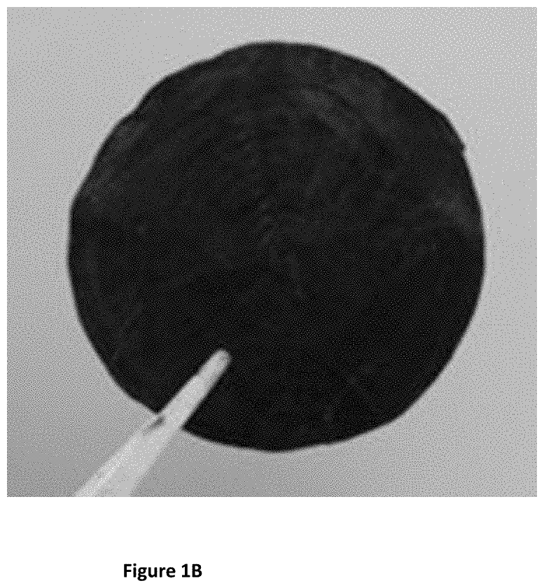

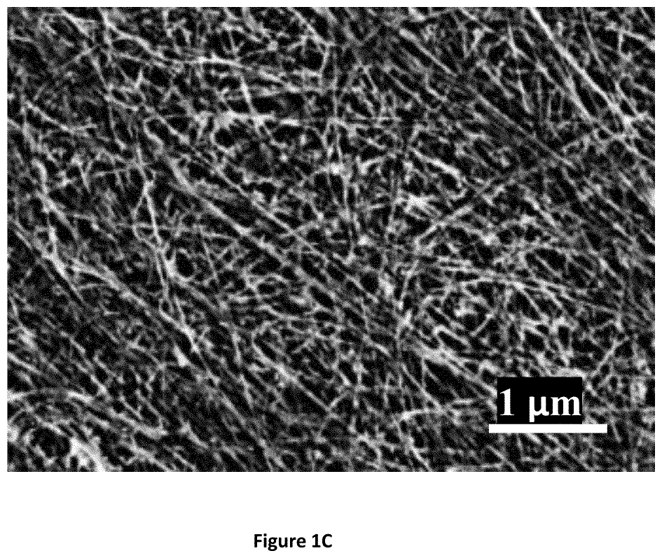

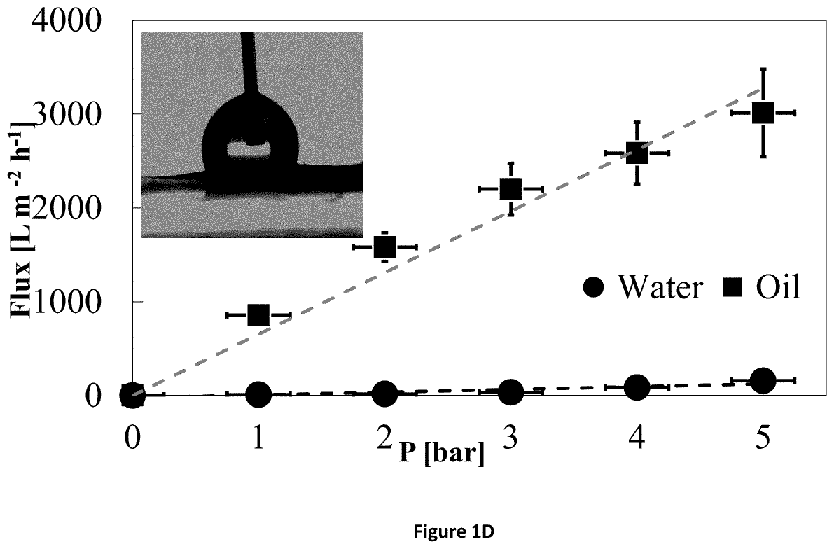

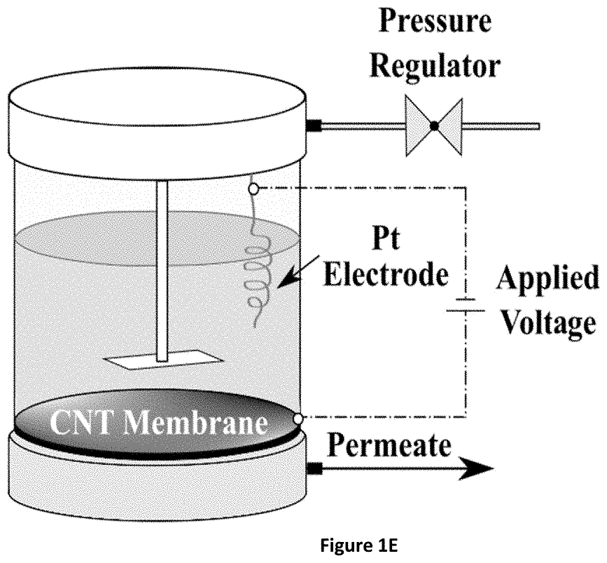

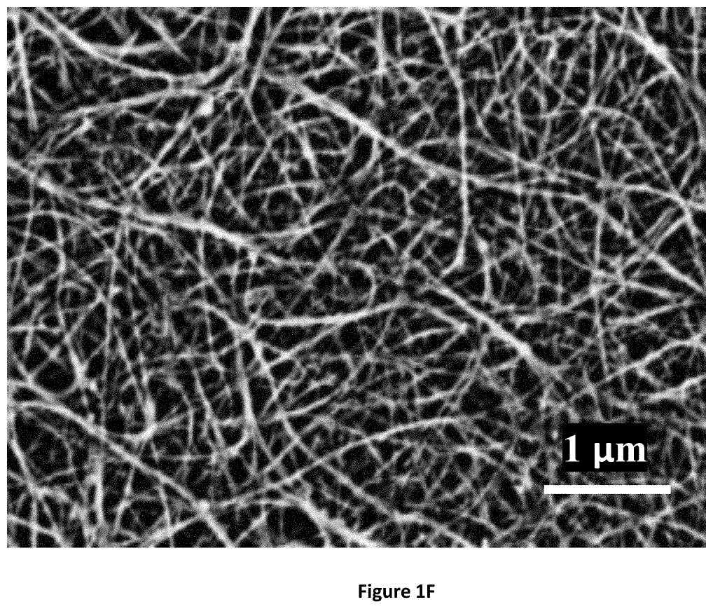

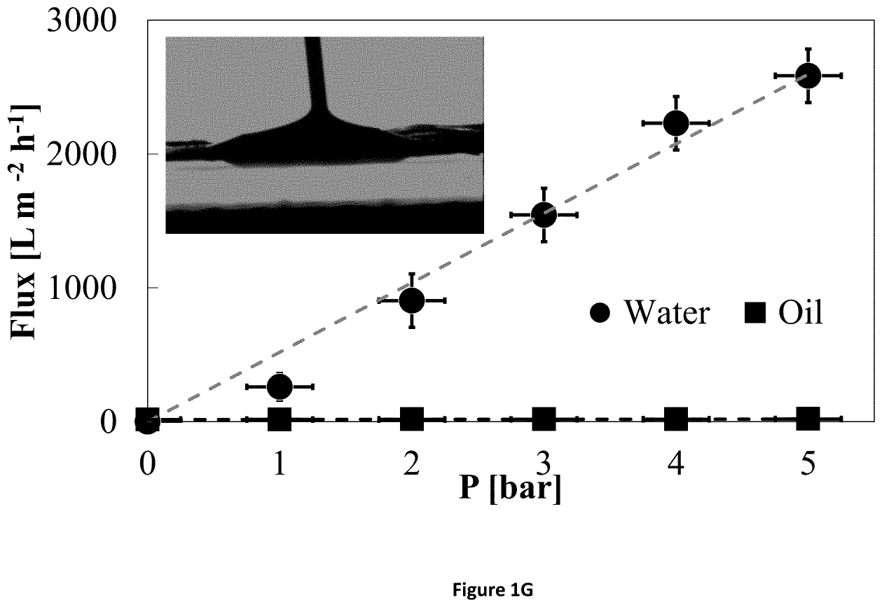

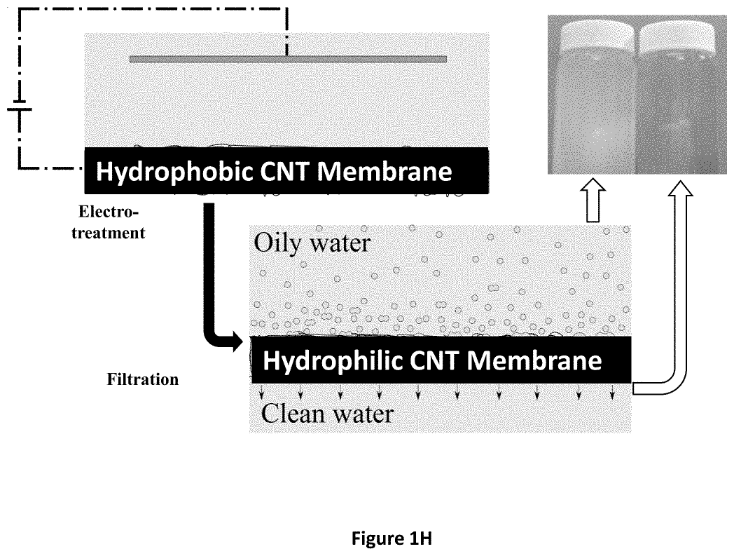

A reference is made to FIG. 1H, showing a non-limiting schematic representation of a separation system in an embodiment thereof

In some embodiments, the separation systems described herein are used for separating water from an aqueous mixture comprising an organic matter (the phrase “organic matter” is described below under section “The Method”). In some embodiments, the organic matter is a hydrophobic substance.

In some embodiments, and without being bound by any particular mechanism, the principle underlying the separation process of the separation systems described herein is based on membrane pore size and membrane surface hydrophilicity.

In some embodiments, “hydrophilic membrane” is defined by water permeability, as described here and above under section “The Article”.

The term “control unit” may refer to a computerized controller that is connected to various elements of the disclosed article (e.g., the filtration membrane).

In some embodiments, the “control unit” refers to a computerized controller that is connected to various elements of the article (e.g., the filtration membrane) either by wire or wirelessly, to transmit operating instructions to these elements and to receive feedback, as confirmation of instructions, sensor measurements, etc., from elements of the article.

In some embodiments, the disclosed system further comprises a computer program product.

In some embodiments, the computer program product comprises a computer-readable storage medium. The computer-readable storage medium may have program code embodied therewith. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified herein. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified hereinthroughout.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the drawings.

Methods for Removing an Organic Matter

According to another aspect of the present invention, there is provided a method for removing an organic matter from an aqueous mixture. In some embodiments, the method comprises the steps of: (i) providing a CNT membrane, (ii) contacting the mixture with the CNT membrane, and (iii) allowing the mixture to pass through the CNT membrane, thereby removing the organic matter from the aqueous mixture.

In some embodiments, the electric potential is a direct-current (DC) potential, in the range of from +1V to +60V, as described herein throughout.

In some embodiments, at least 95% of the organic matter is removed from the aqueous mixture. In some embodiments, at least 96%, at least 97%, at least 98%, at least 99%, at least 99.9%, or at least 99.99% of the initial organic matter is removed from the aqueous mixture.

In some embodiments, organic matter removal is quantitatively evaluated by measuring the TOC (total organic carbon) within the mixture. In some embodiments, TOC is being reduced to 100 ppm. In some embodiments, TOC is being reduced to 10 ppm. In some embodiments, TOC is being reduced to 10 ppm, 9 ppm, 8 ppm, 7 ppm, 6 ppm, 5 ppm, 4 ppm, 3 ppm, 2 ppm, or to 1 ppm, including any value and range therebetween.

In some embodiments, the concentration of the organic matter in the mixture is in the range of from 0.0001% to 30%, by weight. In some embodiments, the concentration of the organic matter in the mixture is in the range of from 0.001% to 20%, by weight. In some embodiments, the concentration of the organic matter in the mixture is in the range of from 0.01% to 10%, by weight. In some embodiments, the concentration of the organic matter in the mixture is in the range of from 0.1% to 1%, by weight. In some embodiments, the concentration of the organic matter is 0.1%, 0.2%, 0.3%, 0.4%, 0.5%, 0.6%, 0.7%, 0.8%, 0.9%, or 1%, including any value and range therebetween.

In some embodiments, the phrase “organic matter”, refers herein to a matter or a mixture of matters that are non-soluble in water. In some embodiments, the term “non-soluble in water” refers to a solubility of an entity of below 5000 ppm, 1000 ppm, 500 ppm, or 100 ppm at 25° C. In some embodiments, the organic matter in the mixture described herein is dispersed to yield a mixture in the form of a colloidal suspension.

In some embodiments, the disclosed method is effective for treating one or more contaminant components, e.g., organic-based components, such as hydrocarbons, and/or organic-based components.

Non-limiting examples of hydrophobic organic-based and hydrocarbon-based contaminant components which may be processed in accordance with the present invention include, but are not limited to, petroleum (crude oils including topped crude oils), hydrocarbons, ketones, aldehydes, aromatic components including aromatic hydrocarbons, phenols and the like, organic materials containing hetero atoms such as nitrogen, sulfur and halogen, e.g., chloride, and the like, dyes, polymeric materials, including, without limitation, polymeric carbohydrates (e.g., polysaccharides), proteins, fatty acids and mixtures thereof. Other contaminants which may be treated in the present process include, for example, and without limitation, materials which are active components in or products of a manufacturing process, such as cyanide or hydrazine, or a process by-product, organic insecticides, herbicides, sewage contamination, and pesticides resulting from soil leaching due to continuous water usage in agriculture, e.g., the production of fruits and vegetables particularly in arid to semi-arid climates.

In some embodiments, the mixture comprises an emulsifier. In some embodiments, the emulsifier is selected from, without being limited thereto, an ionic or a non-ionic surfactant. In some embodiments, the ionic surfactant is selected from an anionic, a cationic, an amphoteric, or a zwitterionic surfactant. In some embodiments, the cationic surfactant is selected from, without being limited thereto, Cetrimonium bromide (CTAB), Cetylpyridinium chloride, (CPC), Benzalkonium chloride (BAC), Benzethonium chloride (BZT), Dimethyldioctadecylammonium chloride, or Dioctadecyldimethylammonium bromide (DODAB). In some embodiments, the anionic surfactant is selected from, without being limited thereto, ammonium lauryl sulfate, sodium lauryl sulfate, sodium myreth sulfate, Docusate (dioctyl sodium sulfosuccinate), Perfluorooctanesulfonate (PFOS), Perfluorobutanesulfonate, Alkyl-aryl ether phosphates, Alkyl ether phosphates, sodium stearate, sodium lauroyl sarcosinate, perfluorononanoate, or perfluorooctanoate.

In some embodiments, the non-ionic surfactant is selected from, without being limited thereto, Decyl glucoside, Lauryl glucoside, Octyl glucoside, Triton X-100, Nonoxynol-9, Glyceryl laurate, Cocamide MEA, cocamide DEA, or Dodecyldimethylamine oxide. In some embodiments, the non-ionic surfactant is Triton x-100.

The term “emulsifier” may refer herein to a nonionic, anionic, cationic or amphoteric surfactant.

General

As used herein the term “about”, unless stated otherwise, refers to ±10%.

The terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

### EXAMPLES

Reference is now made to the following examples, which together with the above descriptions illustrate some embodiments of the invention in a non-limiting fashion.

### Example 1

### Experimental

The feed emulsions were prepared by mixing petroleum ether (PE, bp 100-120° C., Merck) and 5 mM Na2SO4 solution, optionally stabilized with Triton X100 (Sigma Aldrich). Petroleum ether (PE) of 100-120° C. boiling range (Merck) was used as the model oil, and Triton X100 (Sigma Aldrich) was used as a surfactant.

MWCNT mats obtained from Tortech NanoFibers (Ma'alot, Israel) were washed in PE and dried before experiments. Their modification and filtration were carried out in a 50 ml air-pressurized and magnetically stirred dead-end UF cell (Amicon) of active area 13.4 cm² fitted with a Pt-wire counter electrode, while the CNT membraned functioned as the working electrode (FIG. 1A). Electrodes were connected to an appropriate power source (DC or AC of grid frequency 50 Hz).

In filtration experiments the feed was pressurized with compressed air through a pressure regulator. While measuring the flux versus pressure, each point was measured at least twice, but first increasing and the decreasing the pressure, which was found to yield reproducible and reversibly changing flux, without signs of irreversible fouling.

### Example 2

### Characterization

SEM was performed on a Carl Zeiss Ultra Plus High-resolution microscope equipped with a Schottky field emission gun, using in-the-column detector (InLens) at 2 kV and a 3-5 mm working distance.

Attenuated total reflection (ATR)-FTIR spectra were recorded on a Thermo-Nicolet 8700 FTIR spectrometer fitted with a Pike MIRacle attachment with a germanium element. Raman spectra were recorded on an Xplora Raman microscope (Horiba Scientific) with 532 nm laser.

Time-Of-Flight Secondary-Ion-Mass-Spectroscopy (TOF-SIMS) measurements were performed for pristine and oxidized (5 V, 30 min) membranes on a TOF-SIMS 5 spectrometer (ION-TOF GmbH, Germany). Spectra were collected in positive and negative mode using 25 KeV Bi+ analysis ion beam from 100×100 μm2 acquisition area.

XPS spectra were recorded, using Thermo VG Scientific Sigma Probe, with a pass energy of 140 eV with a step size of 0.4 eV, from which the surface chemical composition was determined. The core level binding energies of the different peaks were normalized by setting the binding energy for the C1s at 284.5 eV. The atomic concentrations were calculated using elemental relative sensitivity factors used from Multipak Software library. High Resolution-multiplex spectra were taken at fixed pass energy of 55 eV, with a step size of 0.05 eV. Curve fitting was performed to determine the chemical bonding environment of the C1s using a Gaussian-Lorenzian peak shape with a Shirley type background.

TGA was carried out on a TA Q5000-IR TGA analyzer (New castle, Del., USA). 6-8 mg of specimens were oxidized in dried air from 40° C. to 800° C. at a base ramp rate of 5° C./min using the variable heating rate mode of Hi-Res™.

Mechanical tensile tests were performed on a Shimadzu AGS-50kNX mechanical analyzer. 150×50 mm coupons pre-tensioned with a 3 kN force were stretched at 2 mm/min with an initial gauge length 25 mm.

Electrical conductivity was measured using a HIOKI mΩ HiTESTER 3540 using inline 4-point probing technique.

Optical microscopy was performed in on an upright Axiovert microscope (Nikon) in the phase-contrast mode at ×400 magnification. For imaging a drop of freshly prepared and stirred Triton X100-stabilized solution was placed between a glass slide and a coverslip.

### Example 3

### Results

As described above, prior to experiments, non-woven MWCNT mats (FIG. 1B and 1C), were immersed in PE and dried.

This treatment was found to somewhat “densify” their structure and to reduce water permeation and produce more reproducible oil permeability. Presumably, without being bound by any particular theory or mechanism, the negative capillary pressure, developed in menisci receding between nanotubes upon drying, pulled CNTs together and shrank larger pores with a low Pb, through which water could leak. Filtration of pure PE and water, as well as water contact angle, clearly indicate that pretreated mats are hydrophobic and oil-permeable but barely permeable to water (FIG. 1D).

Without being bound by any particular theory, porous micro-(MF) and ultrafiltration (UF) membranes offer a higher permeability, but are inherently prone to oil fouling. Further, the downside of coarser filters with hydrophilic and oleophobic 20-30 μm pores that separate oil and water using ultra-small hydraulic heads is the very low breakthrough pressure P_{b}, above which oil passes the membrane regardless of its surface characteristics. Using a typical value of oil-water interfacial tension y≈20 mN m⁻¹, and pore or mesh radius rₚ as a measure of curvature of water-oil mensisci, the Young—Laplace equation:

$${P}_{b} ≅ \frac{γ}{{r}_{p}}$$

yields P_{b} is of the order 10 mbar for 20-30 μm pores. This is equivalent to heads of a few centimeters, which may be readily exceeded in a real process and result in oil breakthrough.

On the other hand, the above equation suggests that a robust P_{b} above 1 bar will require rₚ<100 nm.

Here, the novel non-woven multiwall carbon nanotube (MWCNT) mats with a mesh size of ˜30 nm in the UF range that meets well this requirement. These large-area fibrous mats, manufactured using a novel reactive CNT-spinning process may function as free-standing CNT-only UF membranes. The mats have a high permeability, on par with conventional asymmetric UF membranes of similar pore size. They also exhibit excellent thermal, chemical and mechanical stability, far exceeding that of polymeric counterparts.

The PE permeability, i.e. the slope of the flux J_{V} versus applied pressure ΔP, is related to the effective pore radius rₚ through a Hagen-Poiseulle-like relation for fully wetted porous media:

$$\frac{{J}_{V}}{Δ P} = \frac{{r}_{p}^{2}}{8 t μ} \frac{φ}{α}$$

where μ is the fluid viscosity and α is the tortuosity.

Using the results for PE in FIG. 1D, known thickness (t˜50 μm) and porosity ϕ˜0.7, for which α˜124) of the mats, yields rₚ˜30 nm, consistent with SEM micrographs (FIG. 1C).

In situ electro-oxidation of CNT mats was performed within an air-pressurized Amicon filtration cell fitted with a Pt counter-electrode, schematically shown in FIG. 1E. Positive potentials≥5 V applied for a sufficient time left the membrane morphology unaltered (see FIGS. 1C and 1F), but water permeation sharply increased, while contact angle and oil permeability of water-wetted membrane dropped dramatically, i.e., the membrane turned hydrophilic and (underwater) oleophobic (FIG. 1G). High voltages were apparently required to overcome competition with water splitting, starting under 1 V. The water permeability was about half the pristine membrane oil permeability (FIGS. 1D and G), due to different viscosities of water and oil, thereby the above equation yielded identical pore size estimates before and after modification.

While EO preserved the morphology and porosity of the membranes, thermogravimetric analysis (TGA), mechanical and electrical characterization, Raman and FTIR spectroscopies, surface analysis using X-ray photoelectron spectroscopy (XPS) and time-of-flight secondary-ion mass spectroscopy (TOF-SIMS) revealed a clear change.

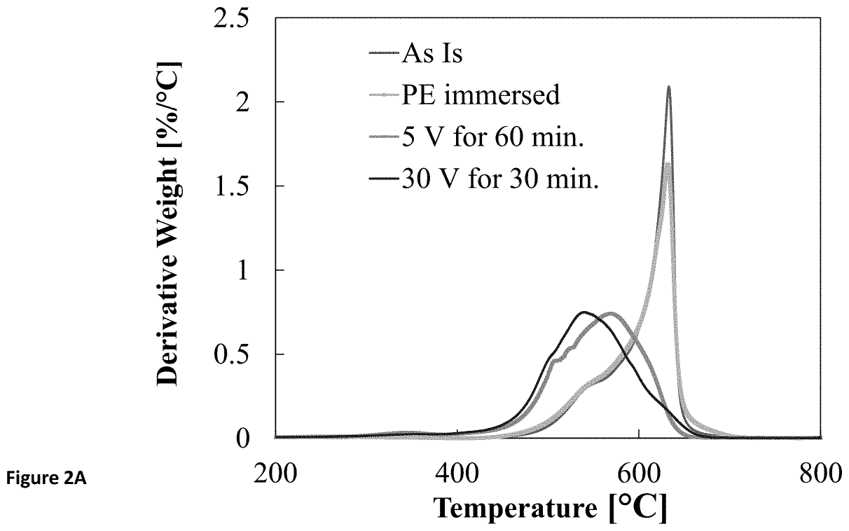

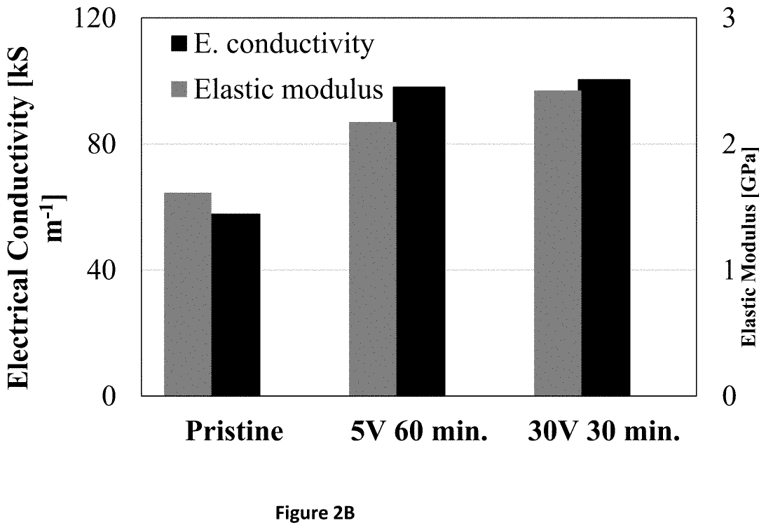

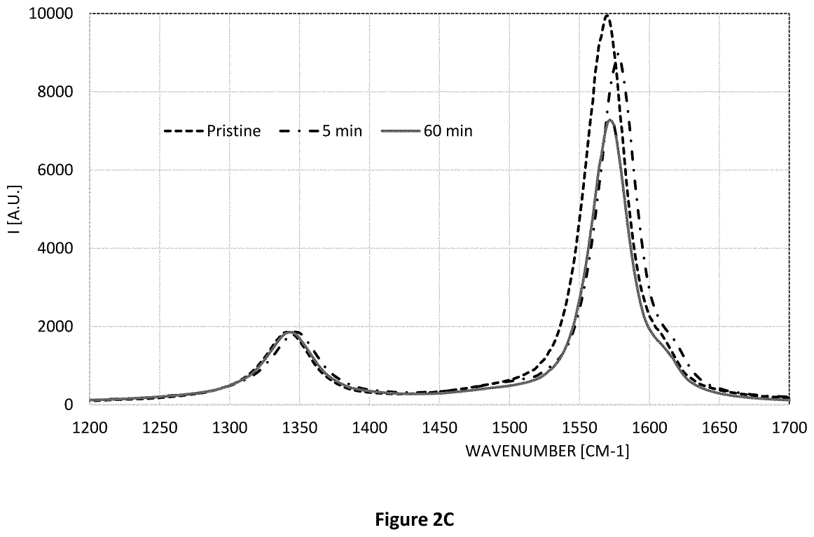

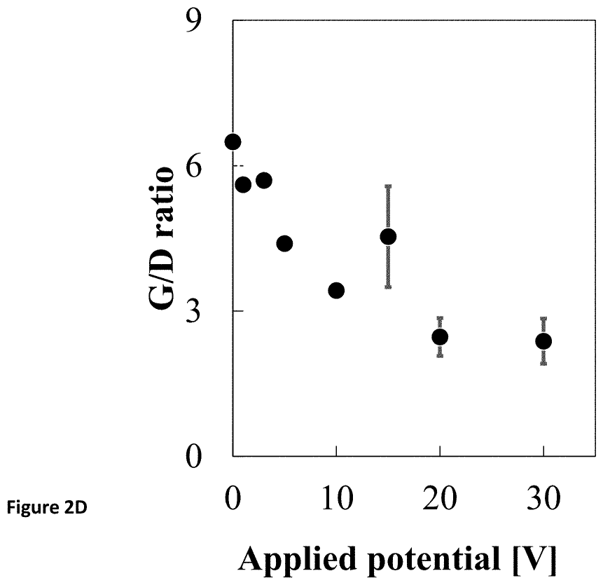

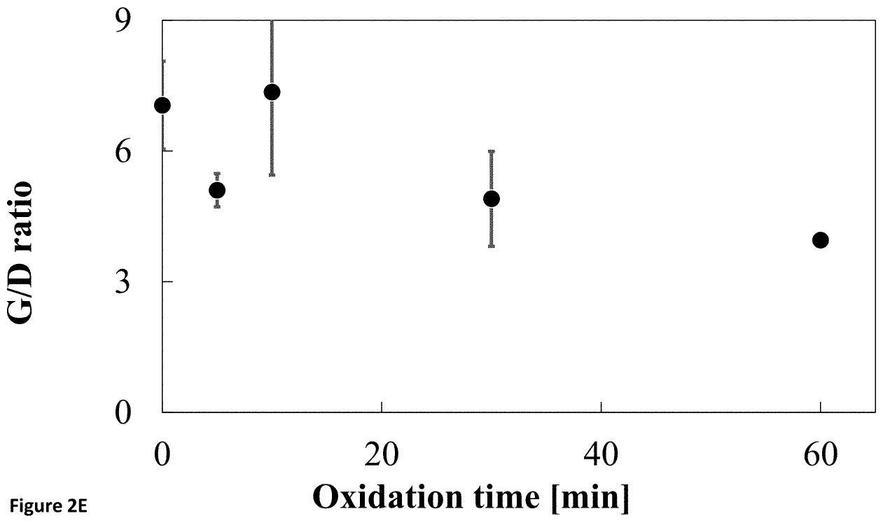

TGA showed that decomposition temperature decreased and its distribution widened (FIG. 2A), consistent with an increased defect rate. Curiously, dry electro-oxidized mats showed elastic modulus increased by 11-34% and electrical conductivity by 70% compared to pristine counterparts (see FIG. 2B and Tables 1 and 2), presenting the results of mechanical tensile tests (Table 1) and electrical conductivity measurements for CNT mats before and after electro-oxidation treatment under specified conditions (Table 2) (average of 3-6 samples).

TABLE 1

| | | UTS | Max | Elastic |
|---|---|---|---|---|
| | No. | Average ± | Strain, | Module, |
| Mechanical | of | std | Avg ± std | Avg ± std |
| Tests | samples | [Mpa] | [%] | [Gpa] |
| As is | 4 | 79 ± 12 | 13.8 ± 2.8 | 1.6 ± 0.2 |
| 5 V 60 min | 6 | 96 ± 5 | 13.6 ± 2.4 | 2.2 ± 0.5 |
| 30 V 30 min (high) | 3 | 88 ± 5 | 7.7 ± 1.6 | 2.4 ± 1.0 |
| 30 V 30 min (low) | 3 | 60 ± 6 | 3.9 ± 0.6 | 1.5 ± 0.3 |

TABLE 2

| | Area | Sheet | Conductivity |
|---|---|---|---|
| Treatment | Density | Resistance | (in line) |
| Description | [g/m⁻²] | [Ohm/sqr] | [kS/m] |
| Pristine CNT I | 19.8 | 0.38 | 57.7 |
| 5 V 60 min | 21.4 | 0.25 | 98.1 |
| Difference [%] | 8.1 | −34.2 | 69.9 |
| Pristine CNT II | 19.9 | 0.37 | 58.5 |
| 30 V 30 min | 21.7 | 0.20 | 100.4 |
| Difference [%] | 9.0 | −45.9 | 71.2 |

Since defects are supposed to reduce electrical conductivity of individual CNTs, the observed increase suggests enhanced bonding between nanotubes, presumably, since oxidation increased surface polarity and removed amorphous impurities, which strengthened inter-tube contacts.

The ratio of the Raman G and D bands (FIG. 2C) is a common indicator of chemical defects in carbon nanomaterials. FIG. 2D and 2E show that, as the voltage or time increased, the G/D ratio declined, consistent with increased defect rate.

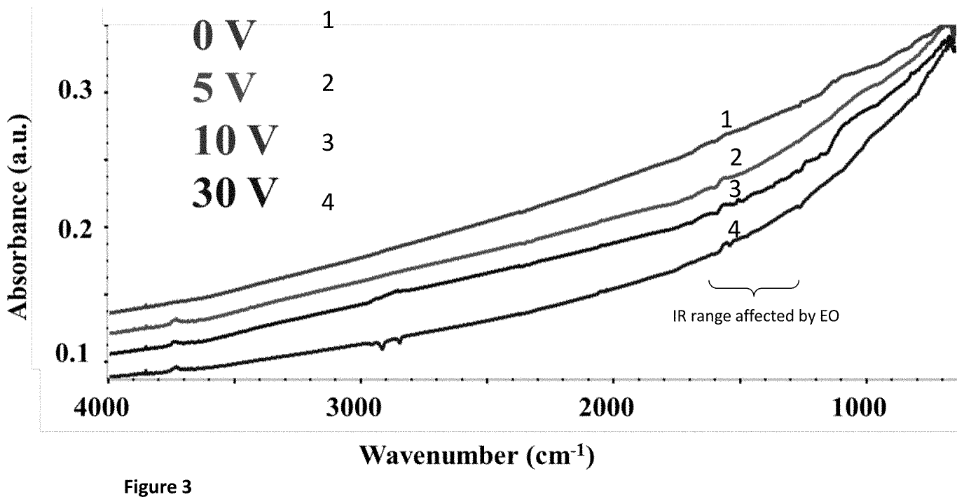

FTIR spectra are featureless for pristine CNTs, as dictated by IR selection rules for symmetric CNT structure. Yet, oxidation breaks the symmetry thereby weak but distinct bands assigned to various oxygen-containing groups and increased water adsorption emerge in the 1000-1700 cm⁻¹ region (FIG. 3).

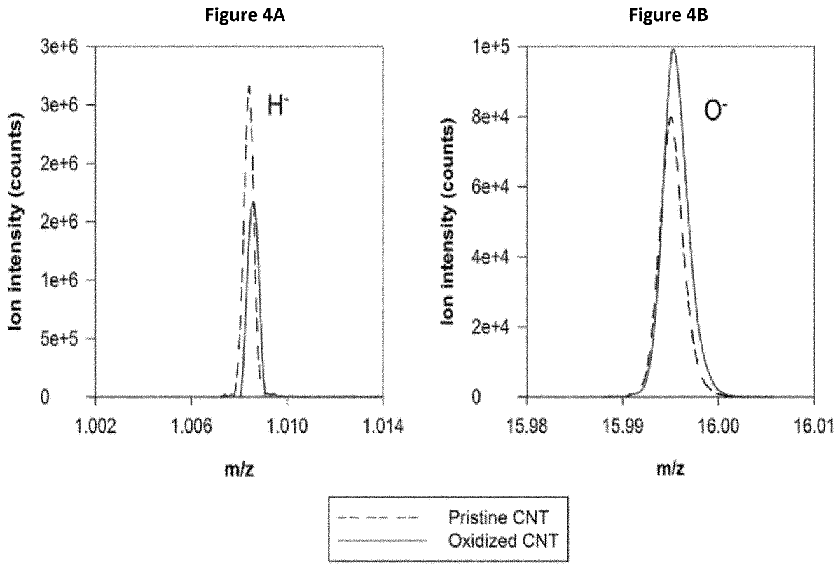

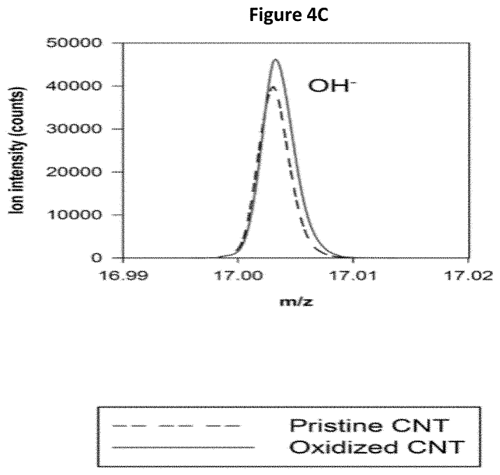

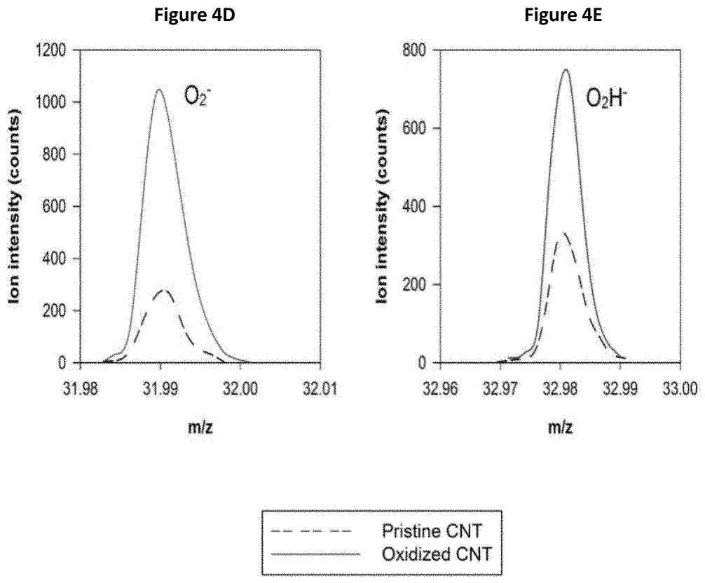

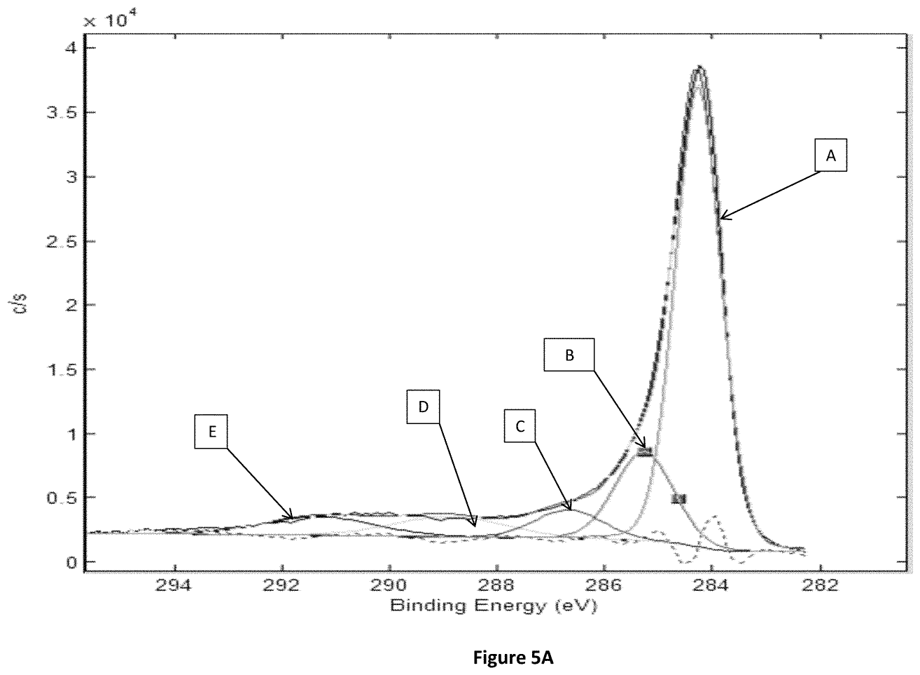

Surface analysis using time-of-flight secondary-ion mass spectroscopy (TOF-SIMS) and X-ray photoelectron spectroscopy (XPS), which showed an increased O and reduced C and H surface content after oxidation (FIGS. 4A-E and 5 and Table 3, showing atomic composition (atomic %) from low-resolution XPS spectra for pristine and oxidized (5V, 30 min) CNT memrbanes).

TABLE 3

| Element (band) | Pristine | Oxidized |
|---|---|---|
| C (C1s) | 95.5 | 84.2 |
| O (O1s) | 2.8 | 8.2 |
| Others (Fe, Cl, Si, N) | 1.7 | 7.6 |

As demonstrated in Table 3, the decrease in C and increase in O content is well evident. These elements were also the dominant species, even though small amounts of other elements were detected as well, mainly Fe, which were apparently residues of the catalyst used in CNT synthesis.

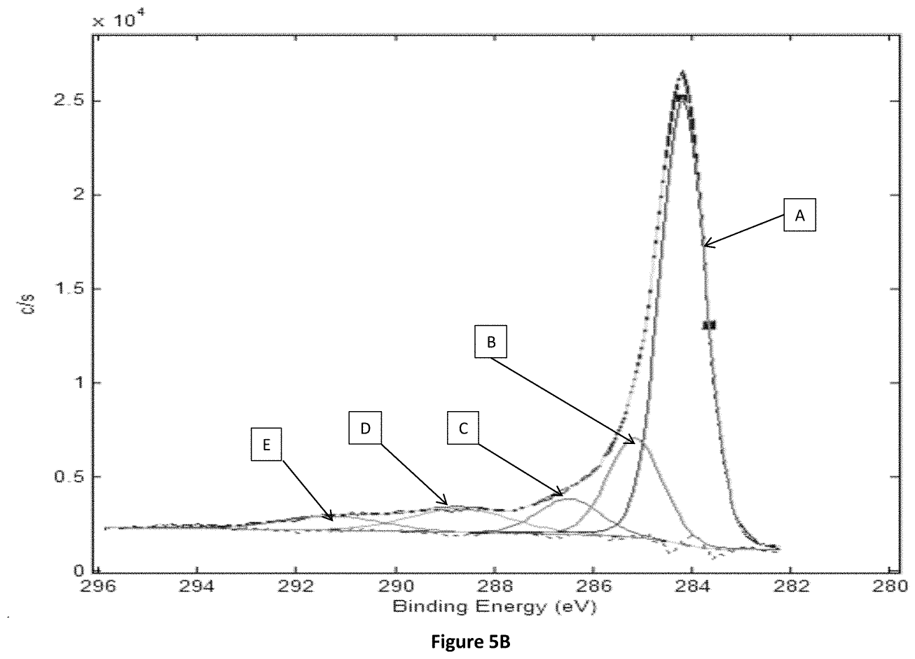

FIG. 5 displays high-resolution spectra of the C1s band of carbon that were fitted to resolve the distribution of binding energy (chemical shifts), indicative of different oxidation and hybridization states of carbon. Even though the difference is not as significant as for the O content deduced from the total areas of C1s and O1s bands, there is a small relative increase in the bands corresponding to the more oxidized states, namely, COH and COOH groups, for the oxidized membranes. It is noteworthy that O1s band could be contributed by impurities as well, in particular, Fe oxide, therefore sub-bands of C1s may be more indicative of the CNT oxidation that the intensity of the O1s band.

TOF-SIMS probes essentially the first atomic layer thereby attenuated H⁻ and strongly enhanced O₂⁻ and O₂H⁻ signals indicate increased content of oxygen-rich groups such as carboxyl.

Negative ion spectra provide the most straightforward evidence of surface oxidation. The results shown in FIGS. 4A-E indicate that after oxidation the surface H content was reduced, while O content increased. As described above, particular significant was increase in the signal of O₂⁻ and O₂H⁻ ions, probably indicating increased amounts of carboxylic groups on the surface.

Conversely, XPS penetrates the entire MWCNT diameter and high-resolution XPS of carbon binding energies (C1s band) shows only a moderate increase in carboxyl bands. This might suggest that oxidation indeed affected primarily the outmost MWCNT walls and preserve their bulk characteristics (electrical, mechanical etc.).

Following in situ electro-oxidation, oil-water separation performance was tested in the same setup (FIG. 1D) using PE-water dispersions, containing 5 mM Na₂SO₄ (to simulate tap-water salinity) and optionally stabilized with 0.4 mM Triton X100 surfactant (twice its critical micellization concentration).

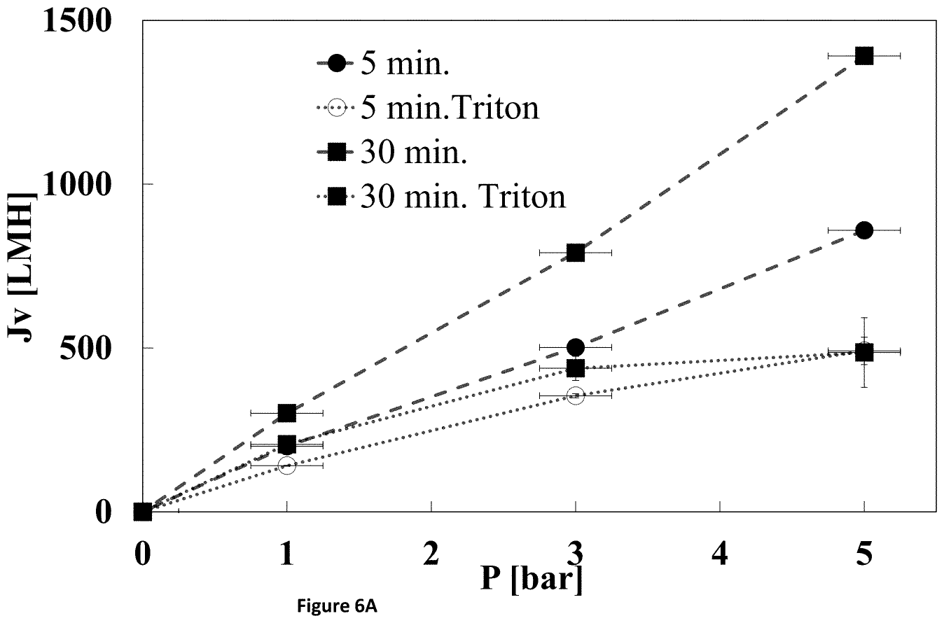

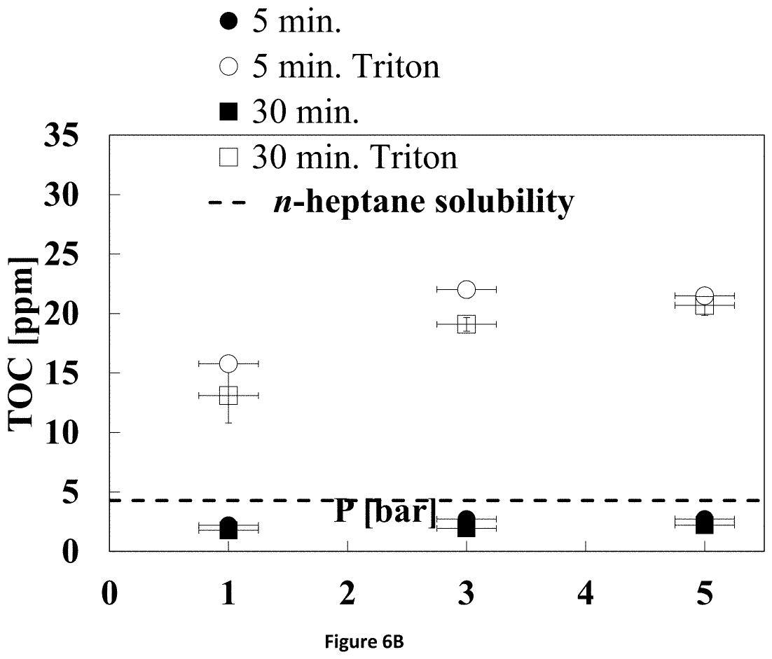

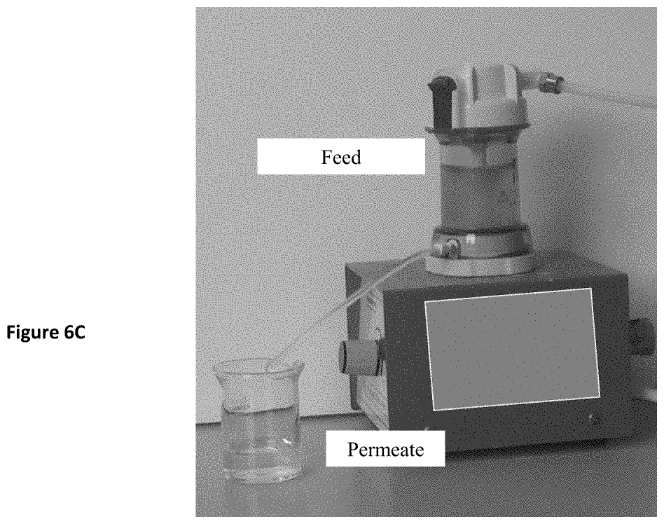

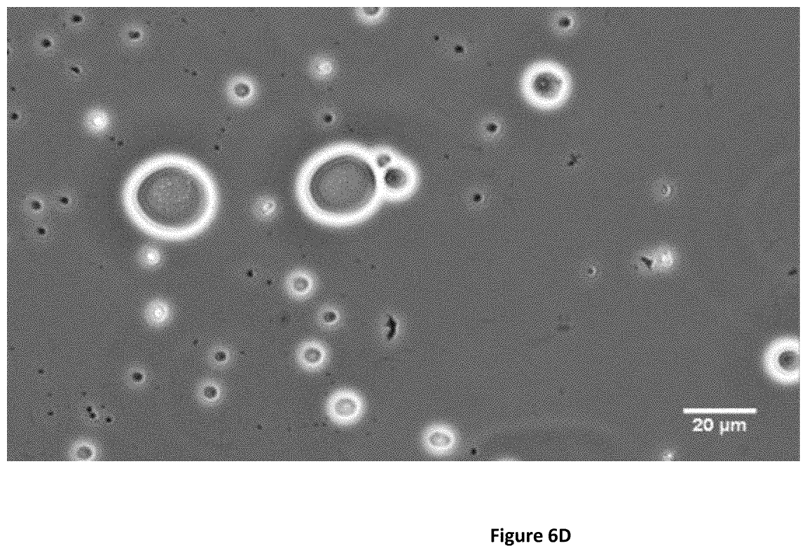

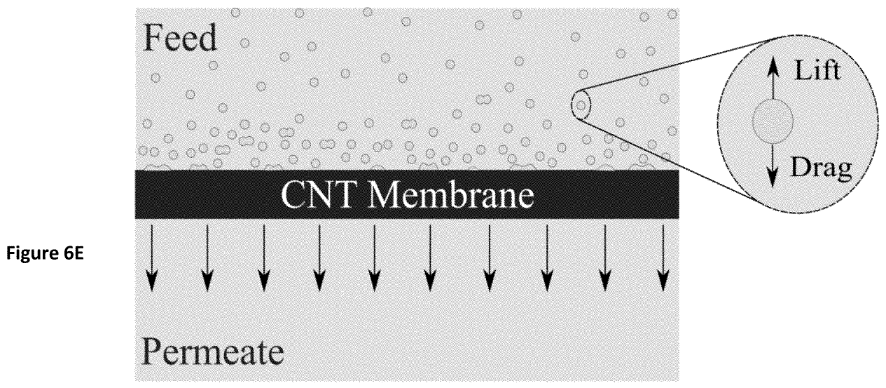

FIG. 6A shows that the fluxes were somewhat lower than for pure water due to build-up of a thin blocking layer of rejected oil on the membrane surface (concentration polarization). Nevertheless, only dissolved organics could reach the permeate, while oil droplets were totally rejected, as was confirmed by measuring chemical oxygen demand of the entire collected permeate volume. Total organic carbon (TOC) analysis supplied a more accurate measure of the organics in permeate. Without surfactant in the feed, it contained around 3-4 ppm TOC (FIG. 6B), which closely corresponds to solubility of n-heptane (boiling point 98° C.), representative of the PE used (dashed line in FIG. 6B).

Surfactant was added to model realistic situations, when oil emulsion may be stabilized by organic impurities. The feed solution became milky due to presence of micron and submicron droplets, however, permeate remained transparent (FIGS. 6C and 3D). Compared to surfactant-free oil emulsions, the permeation rates dropped and tended to plateau with increasing pressure, indicating a stronger concentration polarization, resulting in surface blockage by rejected oil. Note the flux varied reversibly upon pressure cycling, which rules out irreversible fouling as the reason for reduced flux.

However, the enhanced blockage in presence of surfactant is consistent with the change of force balance for reduced droplet size. Indeed, the balance mainly involves inertial lift force that arises in a stirred fluid next to a solid surface and drives droplets away from the surface and the convective drag towards the membrane by the trans-membrane flow, as illustrated in FIG. 6E. Since lift force drops more rapidly than drag when droplet size decreases (as 4th power of size vs 1st power for drag), blockage should increase for surfactant-stabilized emulsions.

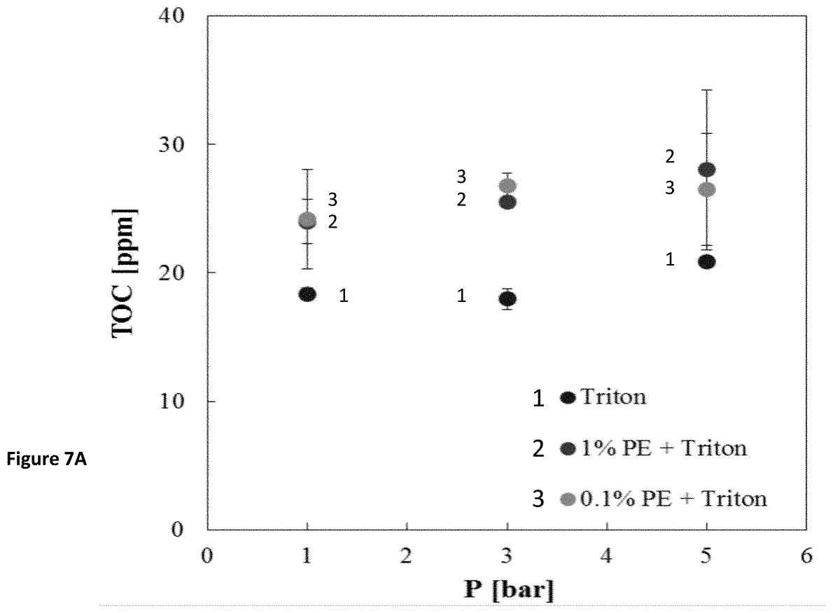

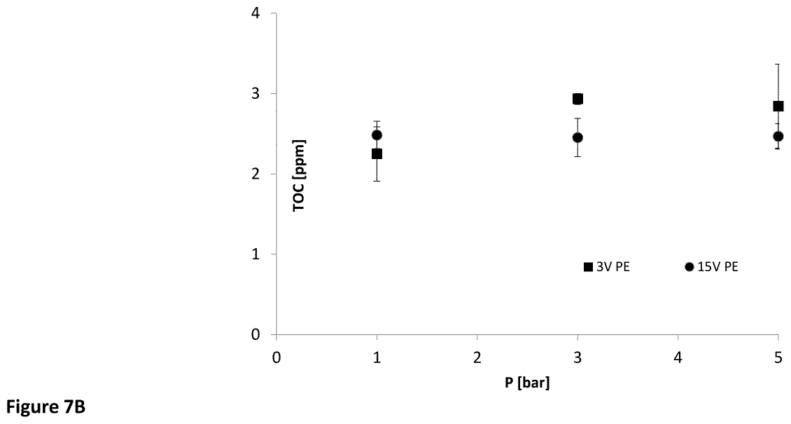

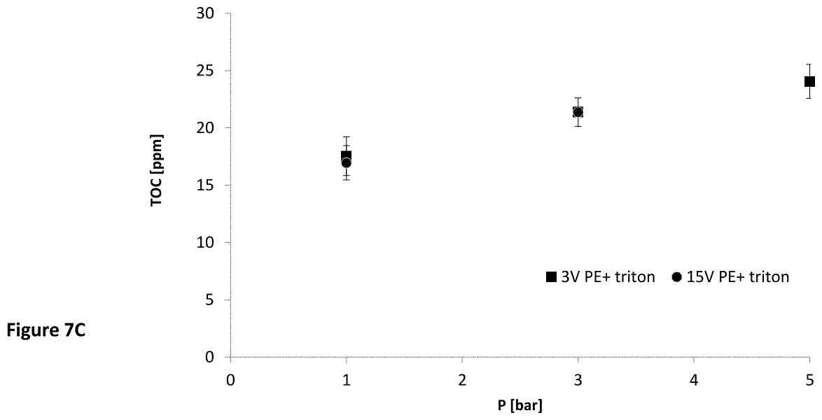

Added surfactant also increased permeate TOC to 20-25 ppm, but the increase was mainly associated with surfactant, as verified by filtering solutions with reduced PE content (0, 0.1, and 1%) and oil-free 0.4 mM Triton X100 solutions (FIG. 6B and FIG. 7A).

The membrane was a CNT mat modified at 15V for 30 min. More specifically, the results displayed in FIG. 7A show that the feed TOC was around 20 ppm for PE-free solutions and increased by a few ppm for PE-containing feed. The increase was similar for both PE contents, 0.1 and 1%, and close to the permeate TOC obtain for surfactant-free 1% PE feed. The results suggest that PE and TOC mainly permeated independently of each other as dissolved fractions. This confirms that only dissolved molecules could reach permeate, while all colloids and larger droplets were effectively rejected.

In additional procedures, a CNT membrane modified at 15 V for 30 min was equilibrated in 300 mL of 1% PE emulsion with added 0.4 mM Triton X100 overnight and thereafter mounted in the 50 mL filtration cell and extended filtration tests were carried out at a pressure of 3 bar.

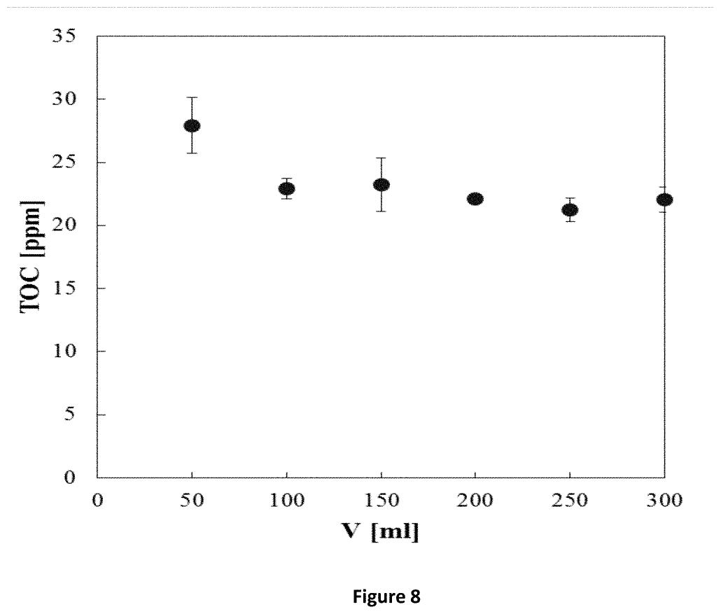

During these tests the cell was repeatedly refilled with a fresh feed mixture, while the permeate composition was monitored. FIG. 8 shows that the permeate TOC did not present any sign of breakthrough and even slightly decreased during the initial period time, which might be due to the permeate washing out oil and surfactant residues that remained in the membrane after equilibration, before it reached the steady state composition. The results suggest the membrane acted as a selective barrier, rejecting the hydrophobic organic components, rather than as an adsorbent. The absence of any evidence of adsorption of PE and, especially, Triton, seems to be consistent with the drastic change in the surface chemistry and hydrophilicity of CNTs induced by the electro-oxidation treatment.

Taken together, the results were unaltered when the membrane and feed were first equilibrated overnight, and then the filtration was run for longer times (FIG. 8). The observed stable performance confirms that the observed oil removal was a result of steady-state rejection rather that adsorption of organics on CNTs.

AC/DC Voltages

Finally, another way of altering the wetting properties of the CNT membranes was examined, using an electric potential. Unlike irreversible electro-oxidation, surface hydrophilicity could also be induced reversibly, by polarization of the membrane-solution interface without an electrode reaction via effects such as electrowetting, electric-field-induced phase separation, or forces induced by mismatch in dielectric properties.

In the present case, membrane conductivity precludes any trans-membrane electric field gradients, yet a voltage applied directly to CNT mats could potentially promote displacement of low-dielectric oil by high-dielectric water from the adjacent solution layer, either in the form of electrowetting or near-surface phase transitions.

Notably, such effects are roughly independent of the sign of the applied potential, and may then be produced by both positive and negative as well as alternating current (AC) potentials. The use of AC instead of DC may then differentiate between such effects and electro-oxidation.

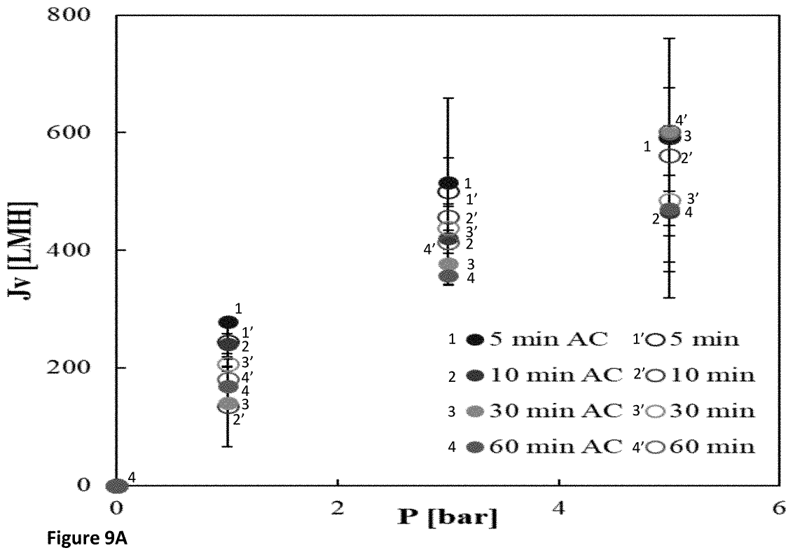

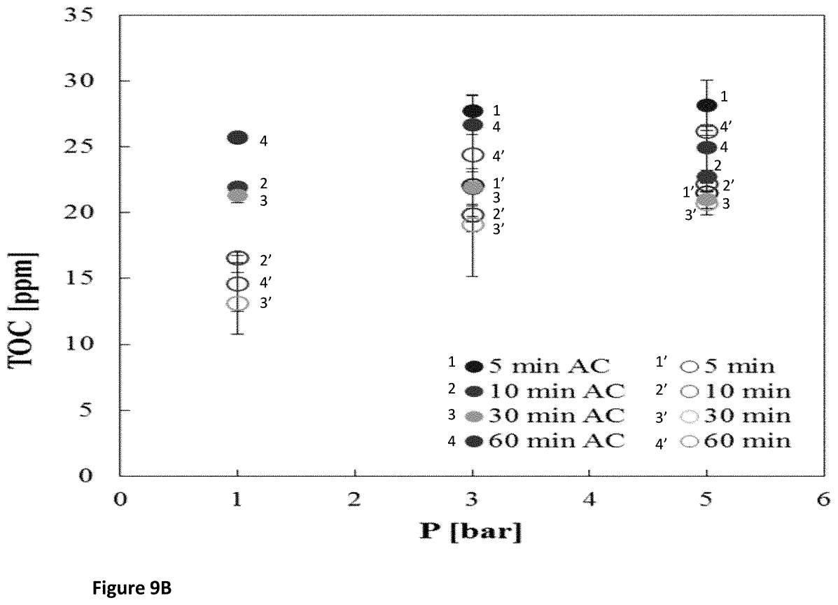

Surprisingly, the tests showed that AC voltages, even as high as 50 V, applied to both pristine and electro-oxidized CNT mats across water or 1% PE solutions concurrently with filtration had no noticeable effect on water permeation and oil rejection (see FIGS. 7B-C, and 9A-B). FIGS. 9A-B display the permeation fluxes and TOC of permeate measured obtained in experiments with and without 50 V AC voltage applied during filtration for a series of CNT membranes electro-oxidized for 30 min at different oxidizing DC potentials (5 to 60 min). The results with 50 V AC applied show no significant difference in permeation rates and permeate TOC, as compared to the parallel tests without applying AC voltage.

When voltage was increased to 200 V, the tap-water-level solution conductivity was already enough to make the solution heat up and boil within minutes. Without being bound by any particular mechanism, it appears that, while on-demand reversible electro-treatment may be attractive for primary separation of crude oil-rich mixtures, it may be problematic for removal of fine oil residues from predominantly aqueous media. In such a case, irreversibly electro-oxidized CNT mats reported here may offer a simple, safe, and robust way of producing highly water-permeable and oil-rejecting CNT membranes.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An article comprising a carbon nanotube (CNT) membrane characterized by permeability of water in the range from 50 to 2000 L/(m² h bar), wherein at least one surface of said membrane is at least partially oxidized, and wherein said membrane is characterized by one or more properties selected from:
(a) Fourier transform infrared (FTIR) spectroscopy exhibiting bands in the range of: from 1000 cm⁻¹ to 1700 cm⁻¹, and from 3500 cm⁻¹ to 4000 cm⁻¹; and/or;
(b) Raman scattering peaks at (i) 1580 cm⁻¹ (G-band), and at (ii) 1350 cm⁻¹ (D-band), wherein a ratio of peak (i) to peak (ii) is at least 20% lower compared to a corresponding ratio of said peaks of non-oxidized CNT membrane.

2. The article of claim 1, wherein said CNT membrane is characterized by permeability of water in the range from 100 to 2000 L/(m² h bar).

3. The article of claim 1, said CNT membrane is characterized by oil breakthrough pressure of at least 0.5 bar.

4. The article of claim 1, wherein said CNT membrane is characterized by a Young's modulus value higher than the Young's modulus value of a nonoxidized pristine CNT membrane by 10% to 40%.

5. The article of claim 1, wherein said CNT membrane is characterized by an electrical conductivity value higher than the electrical conductivity value of a nonoxidized pristine CNT membrane by 60% to 80%.

6. The article of claim 1, wherein said CNT membrane comprises pores having a median size in the range of from 3 nm to 200 nm.

7. The article of claim 1, wherein said CNT is in the form of a multi-walled CNT.

8. The article of claim 1, wherein said CNT membrane is in the form of one or more non-woven sheets.

9. The article of any claim 1, being selected from the group consisting of: a filtration device, an agricultural device, or a microfluidic device.

10. A method for oxidizing a surface of a CNT membrane, the method comprising the step of: applying an electric potential in the range of from +1V to +60 V in/on said CNT membrane.

11. The method of claim 10, wherein said electric potential is a direct-current (DC) potential.

12. The method of claim 10, wherein said applying electric potential is performed for a time duration of from 1 min to 60 min.

13. A separation system comprising the article of claim 1, said separation system further comprising a filtration unit and an inlet, wherein said filtration unit is configured to allow liquid to pass from said inlet to said membrane.

14. A separation system comprising a CNT membrane and a control unit, said control unit being configured to apply an electrical current in/on said membrane prior to the separation so as to oxidize at least one surface of said CNT membrane, wherein said CNT membrane comprises pores having a median size in the range of from 3 nm to 200, and wherein the separation system further comprises a filtration unit having an inlet configured to allow liquid to enter said filtration unit so as to pass through said membrane.

15. The separation system of claim 14, wherein the oxidized CNT membrane is characterized by one or more properties selected from:
(a) Fourier transform infrared (FTIR) spectroscopy exhibiting bands in the range of: from 1000 cm⁻¹ to 1700 cm⁻¹, and from 3500 cm⁻¹ to 4000 cm⁻¹; and/or
(b) Raman scattering peaks at (i) 1580 cm⁻¹ (G-band), and at (ii) 1350 cm⁻¹ (D-band), wherein a ratio of peak (i) to peak (ii) is at least 20% lower compared to a corresponding ratio of said peaks of non-oxidized CNT membrane.

16. The separation system of claim 14, wherein said CNT membrane is characterized by permeability of water in the range from 100 to 2000 L/(m² h bar).

17. The system of claim 13, for separating water from an aqueous mixture comprising an organic matter.

18. (canceled)

19. The system of claim 17, for removing at least 95% of the initial organic matter from said aqueous mixture.

20. The system of claim 17, wherein an initial concentration of said organic matter in said aqueous mixture is in the range of from 0.0001% to 10%, by weight.
